(19) United States
(12) Patent Application Publication
(10) Pub. No.: US 2018/0239402 A1
(43) Pub. Date: Aug. 23, 2018

(54) DUAL-SHAFT STRUCTURE AND ELECTRONIC DEVICE

(71) Applicant: Lenovo (Beijing) Co., Ltd., Beijing (CN)

(72) Inventors: Chunyan WANG, Beijing (CN); Xiaoji LI, Beijing (CN); Junchao LUO, Beijing (CN)

(21) Appl. No.: 15/897,933

(22) Filed: Feb. 15, 2018

(30) Foreign Application Priority Data
Feb. 17, 2017 (CN) 201710088345.0

(51) Int. Cl. G06F 1/16; F16H 25/18; F16C 11/04; E05D 3/18; E05D 11/08; E05D 11/06; E05D 5/10

(52) U.S. Cl. CPC G06F 1/1681; F16H 25/18; F16C 11/04; E05D 3/18; E05D 11/082; E05D 2005/106; E05D 5/10; E05Y 2900/606; E05Y 2201/224; E05Y 2201/218; E05Y 2201/26; E05D 11/06

(57) ABSTRACT

The present disclosure provides a dual-shaft structure which comprises a first shaft, a second shaft being arranged beside the first shaft, and a slider. The first shaft has a protruding first stop pin. The second shaft has a protruding second stop pin. The slider includes a first spiral slot and a second spiral slot. In response to a rotation of the first shaft, the first stop pin travels along the first spiral slot to move the slider linearly along an axial direction of the first shaft. In response to the linear movement of the slider, the second shaft rotates with the first shaft through an interaction between the second spiral slot and the second stop pin.

### CROSS-REFERENCES TO RELATED APPLICATIONS

This application claims the priority of Chinese Patent Application No. CN201710088345.0, entitled “Dual-shaft Structure and Electronic Device,” filed on Feb. 17, 2017, the entire content of which is incorporated herein by reference.

### FIELD OF THE DISCLOSURE

The present disclosure relates to the field of mechanical technologies and, more particularly, relates to a dual-shaft structure and an electronic device applying the dual-shaft structure.

### BACKGROUND

A dual-shaft structure is a shaft structure that includes two shafts. Dual-shaft structures are often being used in various electronic devices, such as notebooks or ultrabooks. A dual-shaft structure may include a synchronous mechanism for synchronizing rotations of the two shafts. The synchronizing mechanism often includes a worm and gear set. However, it may be difficult to manufacture worm and gear sets in very small sizes, thereby making them difficult to be used in thin or ultra-thin electronic devices. It is also costly to manufacture worm and gear sets because of the required precision in the manufacturing process.

### BRIEF SUMMARY OF THE DISCLOSURE

In view of the forgoing, the present disclosure provides a dual-shaft structure and related electronic devices and other devices to solve the above-identified problems.

One aspect of the present disclosure provides comprises a first shaft, a second shaft being arranged beside the first shaft, and a slider. The present disclosure provides a dual-shaft structure which comprises a first shaft, a second shaft being arranged beside the first shaft, and a slider. The first shaft has a protruding first stop pin. The second shaft has a protruding second stop pin. The slider includes a first spiral slot and a second spiral slot. In response to a rotation of the first shaft, the first stop pin travels along the first spiral slot to move the slider linearly along an axial direction of the first shaft. In response to the linear movement of the slider, the second shaft rotates with the first shaft through an interaction between the second spiral slot and the second stop pin.

Further, a spiral direction of the first spiral slot is opposite of that of the second spiral slot.

In some embodiments, the first shaft has N stop pins along the axial direction of the first shaft, N being an integer not less than 2; and the slider has N spiral slots corresponding to the N stop pins of the first shaft, each of the N stop pins being located inside a corresponding spiral slot.

In some embodiments, the second shaft has M stop pins along the axial direction of the second shaft, M being an integer not less than 2; and the slider has M spiral slots corresponding to the M stop pins of the second shaft, each of the M stop pins being located inside a corresponding spiral slot.

In some embodiments, in response to a rotation of the first shaft, the N stop pins on the first shaft travel along the N spiral slots to move the slider linearly along the axial direction of the first shaft; and in response to the linear movement of the slider, the second shaft rotates with the first shaft through an interaction between the M spiral slots and the M stop pins on the second shaft.

In some embodiments, N equals to M.

In some embodiments, the dual-shaft structure comprises at least one fixture being arranged between the first shaft and the second shaft to connect the first shaft and the second shaft.

In some embodiments, the dual-shaft structure comprises a torque plate having a first mounting hole and a second mounting hole. The first shaft passes through the first mounting hole and has an interference fit with the first mounting hole; and the second shaft passes through the second mounting hole and has an interference fit with the second mounting hole.

In some embodiments, the dual-shaft structure comprises a housing holding the first shaft, the second shaft, and the slider.

Another aspect of the present disclosure provides an electronic device, comprising a first member, a second member, and a dual-shaft structure. The dual-shaft structure comprises a first shaft having a protruding first stop pin; a second shaft, having a protruding second stop pin; and a slider including a first spiral slot and a second spiral slot. In response to a rotation of the first shaft, the first stop pin travels along the first spiral slot to move the slider linearly along an axial direction of the first shaft; and in response to the linear movement of the slider, the second shaft rotates with the first shaft through an interaction between the second spiral slot and the second stop pin. Further, the first member is connected to the first shaft of the dual-shaft structure; and the second member is connected to the second shaft of the dual-shaft structure.

In some embodiments, a spiral direction of the first spiral slot is opposite of that of the second spiral slot.

In some embodiments, the first member comprises a display screen; and the second member comprises a keyboard.

In some embodiments, the first member and the second member rotate together with the first shaft and second shaft respectively.

Another aspect of the present disclosure provides a device, comprising a first member, a second member, and a dual-shaft structure. The dual-shaft structure comprises a first shaft having a protruding first stop pin; a second shaft, having a protruding second stop pin; and a slider including a first spiral slot and a second spiral slot. In response to a rotation of the first shaft, the first stop pin travels along the first spiral slot to move the slider linearly along an axial direction of the first shaft; and in response to the linear movement of the slider, the second shaft rotates with the first shaft through an interaction between the second spiral slot and the second stop pin. Further, the first member is connected to the first shaft of the dual-shaft structure; and the second member is connected to the second shaft of the dual-shaft structure.

In some embodiments, a spiral direction of the first spiral slot is opposite of that of the second spiral slot.

In some embodiments, the first member comprises a display screen; and the second member comprises a keyboard.

In some embodiments, the first member and the second member rotate together with the first shaft and second shaft respectively.

Other aspects of the present disclosure can be understood by those skilled in the art in light of the description, the claims, and the drawings of the present disclosure.

The dual-structure and the electronic device provided by the present disclosure utilize the stop pins on the first shaft and the second shaft to interact with the slider to achieve a synchronous rotation of the first and second shafts. The synchronizing complicated and delicate mechanism by worms and gears is omitted. The dual-shaft structure provided herein is smaller and simpler, and the involving production and assembly are easier so that reduce rejection rate can be reduced. It therefore can bring thinning of the electronic devices and decreasing production cost as expected.

### BRIEF DESCRIPTION OF THE DRAWINGS

The following drawings are merely examples for illustrative purposes according to various disclosed embodiments and are not intended to limit the scope of the present disclosure.

FIG. 1 shows an exploded schematic diagram of a dual-shaft structure consistent with the present disclosure;

FIG. 2 is a schematic diagram of the dual-shaft structure shown in FIG. 1 in assembly;

FIG. 3 shows a schematic diagram of an assembly relationship between a torque plate and the shafts according to the present disclosure;

FIG. 4 is an assembled schematic diagram of another dual-shaft structure consistent with the present disclosure;

FIG. 5 shows a side view of the dual-shaft structure as shown in FIG. 4; and

FIG. 6 is an exploded schematic diagram of the dual-shaft structure as shown in FIG. 4 consistent with the present disclosure.

### DETAILED DESCRIPTION

Reference will now be made in detail to exemplary embodiments of the disclosure, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

Other embodiments of the disclosure will be apparent to those skilled in the art from consideration of the specification and practice of the disclosure provided herein. It is intended that the specification and examples be considered as exemplary only, with a true scope and spirit of the disclosure being indicated by the claims.

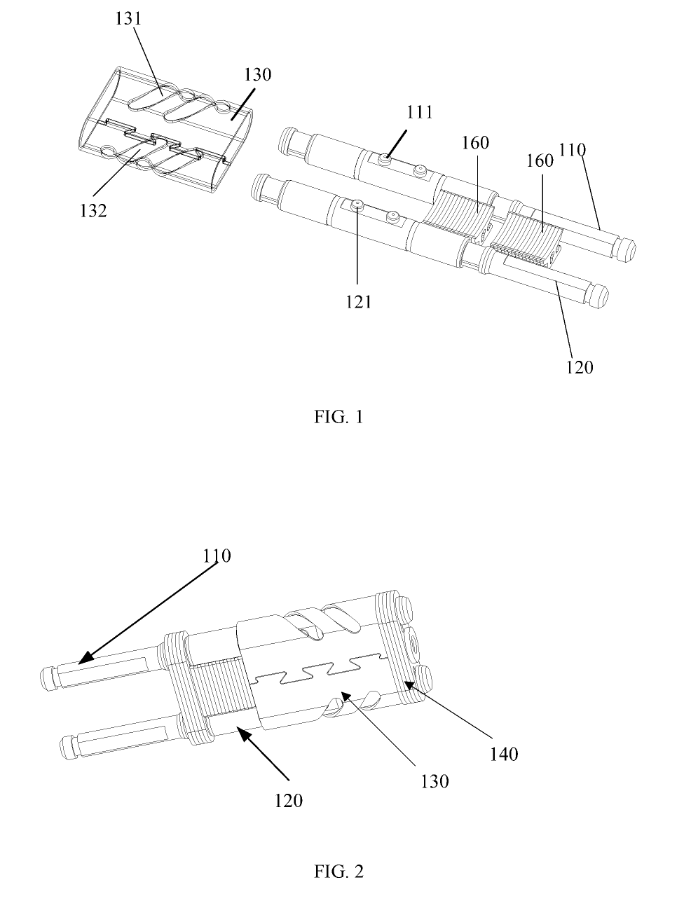

FIG. 1 shows an exploded structural schematic diagram of a dual-shaft structure consistent with the present disclosure. FIG. 2 is a structural schematic diagram of the dual-shaft structure shown in FIG. 1. As illustrated in FIGS. 1 and 2, the present disclosure provides a dual-shaft structure, comprising a first shaft 110, a second shaft 120 and a slider 130. In some embodiments, the first shaft 110 and the second shaft 120 are arranged side by side. More specifically, the first shaft 110 may be arranged in parallel with the second shaft 120. In some instances, the two shafts 110 and 120 may be secured by at least one fixture 160 in between the two shafts.

At least one protruding first stop pin 111 may be provided on an outer surface of the first shaft 110, and at least one protruding second stop pin 121 may be provided on an outer surface of the second shaft 120. On the slider 130, at least one first spiral slot 131 and at least one second spiral slot 132 are provided. The first spiral slot 131 and the second spiral slot 132 may correspond to the protruding first stop pin 111 and the protruding second stop pin 121 respectively. In one embodiment, as the slider 130 is sleeved onto the first shaft 110 and the second shaft 120. In response to a rotation of the first shaft 110, the first stop pin 111 of the first shaft 110 travels along the first spiral slot 131. The movement of the first stop pin 111 pushes the slider 130 to move linearly along an axial direction of the first shaft 110. And in response to the linear movement of the slider 130, through an interaction between the second spiral slot 132 and the second stop pin 121, the second shaft 120 rotates with the first shaft 110 synchronously.

Consistent with the present disclosure, there can be one or more of the first stop pins 111 and the second stop pins 121, such as two or three first stop pins 111 and second stop pins 121. In some instances, there may be two first stop pins 111 and two second stop pins 121. The first stop pin 111 and the second stop pin 121 protrude outwardly from an outer surface of the corresponding shafts 110 and 120 and may be perpendicular to axes of the corresponding shaft respectively.

In some embodiments, the first stop pin 111 and the second stop pin 121 may be formed as a whole in conjunction with the corresponding shafts, or being mounted onto the shafts. In one instance, the outer surfaces of the first shaft 110 and the second shaft 120 may be provided with screw holes respectively, and the first stop pin 111 and the second stop pin 121 may be fixed to the corresponding shafts 110 and 120 by means of screws, respectively. The screws as referred herein may comprise nuts and bolts. A radius of the nut may be greater than that of the bolt. Also, a diameter of the nut is greater than a diameter of the first spiral slot 131 and the second spiral slot 132 respectively to prevent the slider 130 from being apart from the shafts 110, 120. The configuration and format of the first stop pin 111 and the second stop pin 121 are not limited. In some embodiments, the first stop pin 111 and the second stop pin 121 are protrusions out of the first shaft 110 and the second shaft 120, which constraint the movement of slider 130 and prevent the slider 130 from being separated from the shafts 110 and 120.

The first spiral slot 131 and the second spiral slot 132 may be spiral openings provided on a surface of the slider 130 such that the first stop pin 111 can move inside the first spiral slot 131 and the second stop pin 121 can move inside the second spiral slot 132.

By the interaction of the stop pins 111 and 121 with the slider 130, when one of the shafts rotates, the other shaft is pushed/pulled to rotate synchronously, thereby achieving a synchronous rotation of the first shaft 110 and the second shaft 120. By implementing slider 130 of the present disclosure, a synchronous rotation of the first and second shafts 110 and 120 can be realized, and the size of the dual-shaft structure can be reduced with respect to a synchronizing mechanism by worm and gear sets. Because of the reduced size of the dual-shaft structure, it can be implemented in thin electronic devices.

In one instance, a spiral direction of the first spiral slot 131 may be opposite of that of the second spiral slot 132. The opposite direction as referred herein can be understood in which, as the first spiral slot 131 and the second spiral slot 131 are arranged side by side, being viewed from one side, the first spiral slot 131 would rotate counterclockwise on the first shaft 110, and the second spiral slot 132 would rotate clockwise on the second shaft 120.

In some instances, the first shaft 110 may have, on the outer surface, N of the first stop pins 111 along the axial direction of the first shaft 110. N herein may be an integer not less than 2. Further, the slider 130 may be also provided with N of the first spiral slots 131. In one instance, the N first stop pins 111 may be aligned on the first shaft 110. As the slider 130 is sleeved onto the shafts 110 and 120, the n-th stop pin may be located inside the n-th first spiral slot, wherein n is a positive integer not greater than N.

In some embodiments, the number of the first spiral slots 131 may be equal to that of the first stop pins 111. That is, one of the first spiral slots 131 may receive and interact with one of the first stop pins 111 respectively. In this case, through the arrangement of a plurality of first stop pins 111, an interaction force between the first stop pin 111 and the first spiral slot 131 can be more distributed when the two shafts 110 and 120 rotate synchronously, thereby prolonging the service life of the individual spiral slots and stop pins as well as the whole dual-shafts structure.

Furthermore, the outer surface of the second shaft 120 may have M of the second stop pins 121. M may be an integer not less than 2. In one instance, the M second stop pins 121 may be aligned on the second shaft 120. The slider 130 may be provided with M second spiral slots 132 corresponding to the M second stop pins 121. The m-th second stop pin 121 may be located inside the m-th second spiral slot 132, wherein m is a positive integer not greater than M.

Likewise, there may be one or more of the second stop pins 121 and the second spiral slots 132. As the slider 130 is sleeved onto the first and second shafts 110 and 120, one of the second stop pin 121 can travel inside and along the second spiral slot 132 respectively. In some instances, N may be equal to M. That is, the number of the first stop pins 111 may equal to the number of the second stop pin 121.

Consistent with the present disclosure, the first shaft 110 and the second shaft 120 may have a same radius. In that case, N can be equal to M. In other cases, a ratio of N to M may be negatively correlated with a radius ratio between the first shaft 110 and the second shaft 120. For example, the ratio of N to M is inversely proportional to the radius ratio of the first shaft 110 to the second shaft 120.

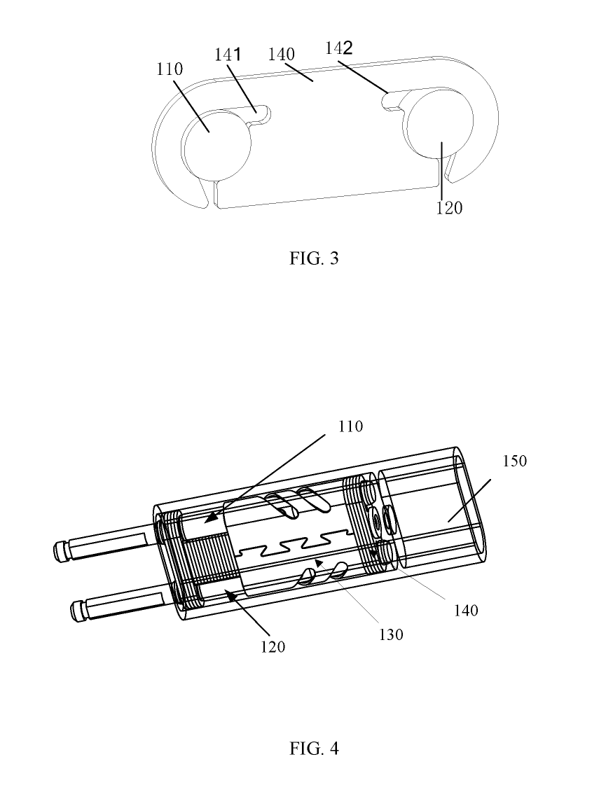

As illustrated in FIGS. 2 and 3, in some embodiments, the dual-shaft structure may further comprise at least one torque plate 140 which includes a first mounting hole 141 and a second mounting hole 142. The first shaft 110 passes through the first mounting hole 141 and has an interference fit with the first mounting hole 141 to provide torque provided by the first shaft 110. And the second shaft 120 passes through the second mounting hole 142 and has an interference fit with the second mounting hole 142 to provide torque needed by the second shaft 120. There may be more than one torque plates 140. In some embodiments, a plurality of the torque plates 140 may be arranged in combination in order to provide more torque.

Consistent with the present disclosure, the first shaft 110 and the second shaft 120 may be installed inside the corresponding mounting holes 141 and 142 and, through the interference fit between shaft and hole, the required torque may be provided. By adopting this mechanism, the supported torque can be larger. That is, a smaller sized dual-shaft structure can be used to support the same weight of items. As a result, thinning of the electronic devices can be realized using such a dual-shaft structure.

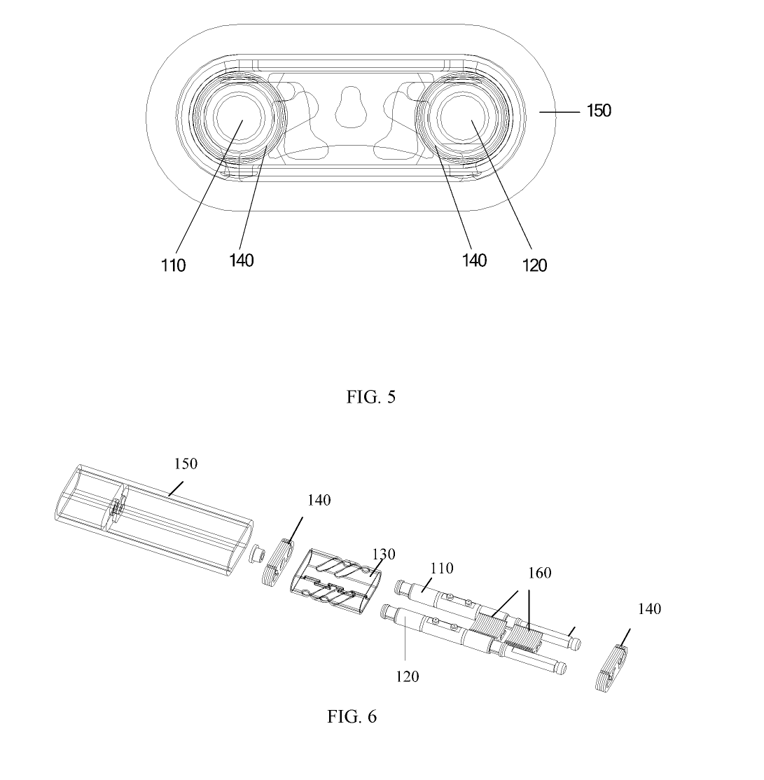

FIG. 5 shows a side view of the dual-shaft structure of another embodiment as shown in FIG. 4. FIG. 6 shows an exploded view of the dual-shaft structure. As depicted, the dual-shaft structure may further comprise a housing 150. The housing 150 may be arranged outside the first shaft 110, the second shaft 120 and the slider 130 to protect inner mechanism of the dual-shaft structure. The torque plates 140 may provide required torque. The housing 150 may protect the inner components of the dual-shaft structure to extend the service life.

The present disclosure may further provide an electronic device, comprising a first member, a second member (not shown) and a dual-shaft structure in any embodiment as described above. The first member may be connected to the first shaft 110 of the dual-shaft structure; and the second member may be connected to the second shaft 120 of the dual-structure.

In some embodiments, the dual-shaft structure may be connected to the first and second members so that a user can adjust a relative angle or position between the first member and the second member. In embodiments implementing the dual-shaft structure provided by the present disclosure, a new synchronizing mechanism, including the slider, may be introduced to support a smaller sized device and provide more stable torque.

The electronic devices may refer to electronic devices with rotation shafts, such as notebooks or ultrabooks. In some examples, the first member may comprise a display screen, while the second member may comprise a keyboard. The display screen may refer to a liquid crystal display (LCD) screen, an electronic ink display screen, a projection display screen, or the like. And the keyboard may include various types of physical keyboards or virtual keyboards. The physical keyboard may comprise a film keyboard or a mechanical keyboard, and the virtual keyboard may include a keyboard formed by display or projection. In another instance, the second member may also comprise a display screen, wherein the display screen can show a virtual keyboard to facilitate user input.

The present disclosure may further provide a mechanical device, comprising a first member, a second member (not shown) and a dual-shaft structure in any embodiment as described above. The first member may be connected to the first shaft 110 of the dual-shaft structure; and the second member may be connected to the second shaft 120 of the dual-structure. In some embodiments, the first member and the second member may be flat structures, such as flat panels.

As described above, the disclosed embodiments are exemplary. The scope of the present disclosure is not limited there to the specific embodiments. Other embodiments of the disclosure would be apparent to those skilled in the art from consideration of the specification and practice of the present disclosure herein. It is intended that the specification and embodiments be considered as exemplary only, with a true scope and spirit of the disclosure being indicated by the claims.

What is claimed is:

1. A dual-shaft structure, comprising:
a first shaft having a protruding first stop pin;
a second shaft, having a protruding second stop pin; and
a slider including a first spiral slot and a second spiral slot, wherein:
in response to a rotation of the first shaft, the first stop pin travels along the first spiral slot to move the slider linearly along an axial direction of the first shaft; and in response to the linear movement of the slider, the second shaft rotates with the first shaft through an interaction between the second spiral slot and the second stop pin.

2. The dual-shaft structure according to claim 1, wherein: a spiral direction of the first spiral slot is opposite of that of the second spiral slot.

3. The dual-shaft structure according to claim 1, wherein:
the first shaft has N stop pins along the axial direction of the first shaft, N being an integer not less than 2; and
the slider has N spiral slots corresponding to the N stop pins of the first shaft, each of the N stop pins being located inside a corresponding spiral slot.

4. The dual-shaft structure according to claim 3, wherein:
the second shaft has M stop pins along the axial direction of the second shaft, M being an integer not less than 2; and
the slider has M spiral slots corresponding to the M stop pins of the second shaft, each of the M stop pins being located inside a corresponding spiral slot.

5. The dual-shaft structure according to claim 4, wherein: N equals to M.

6. The dual-shaft structure according to claim 4, wherein in response to a rotation of the first shaft, the N stop pins on the first shaft travel along the N spiral slots to move the slider linearly along the axial direction of the first shaft; and in response to the linear movement of the slider, the second shaft rotates with the first shaft through an interaction between the M spiral slots and the M stop pins on the second shaft.

7. The dual-shaft structure according to claim 1, further comprising at least one fixture being arranged between the first shaft and the second shaft to connect the first shaft and the second shaft.

8. The dual-shaft structure according to claim 1, further comprising:
a torque plate having a first mounting hole and a second mounting hole; wherein:
the first shaft passes through the first mounting hole and has an interference fit with the first mounting hole; and
the second shaft passes through the second mounting hole and has an interference fit with the second mounting hole.

9. The dual-shaft structure according to claim 1, further comprising a housing holding the first shaft, the second shaft, and the slider.

10. An electronic device, comprising a first member, a second member, and a dual-shaft structure, the dual-shaft structure comprising:
a first shaft having a protruding first stop pin;
a second shaft, having a protruding second stop pin; and
a slider including a first spiral slot and a second spiral slot; wherein:
in response to a rotation of the first shaft, the first stop pin travels along the first spiral slot to move the slider linearly along an axial direction of the first shaft; and in response to the linear movement of the slider, the second shaft rotates with the first shaft through an interaction between the second spiral slot and the second stop pin;
the first member is connected to the first shaft of the dual-shaft structure; and
the second member is connected to the second shaft of the dual-shaft structure.

11. The electronic device according to claim 10, wherein: a spiral direction of the first spiral slot is opposite of that of the second spiral slot.

12. The electronic device according to claim 11, wherein:
the first member comprises a display screen; and
the second member comprises a keyboard.

13. The electronic device according to claim 11, wherein the first member and the second member rotate together with the first shaft and second shaft respectively.

14. A device, comprising a first member, a second member, and a dual-shaft structure, the dual-shat structure comprises:
a first shaft having a protruding first stop pin;
a second shaft, having a protruding second stop pin; and
a slider including a first spiral slot and a second spiral slot; wherein:
in response to a rotation of the first shaft, the first stop pin travels along the first spiral slot to move the slider linearly along an axial direction of the first shaft; and in response to the linear movement of the slider, the second shaft rotates with the first shaft through an interaction between the second spiral slot and the second stop pin;
the first member is connected to the first shaft of the dual-shaft structure; and
the second member is connected to the second shaft of the dual-shaft structure.

15. The device according to claim 14, wherein: a spiral direction of the first spiral slot is opposite of that of the second spiral slot.

16. The device according to claim 15, wherein the first member and the second member rotate with the first shaft and second shaft respectively.
